(19) United States
(12) Patent Application Publication
(10) Pub. No.: US 2008/0123620 A1
(43) Pub. Date: May 29, 2008

(54) APPARATUS AND METHOD FOR TRANSMITTING/RECEIVING MAC HEADER IN MOBILE COMMUNICATION SYSTEM

(75) Inventors: Min-Suk Ko, Suwon-si (KR); Soeng-Hun Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/943,115

(22) Filed: Nov. 20, 2007

(30) Foreign Application Priority Data
Nov. 20, 2006 (KR) 2006-0114775

(51) Int. Cl. H04J 3/24

(52) U.S. Cl. 370/349

(57) ABSTRACT

A method and an apparatus for transmitting/receiving a MAC header in a mobile communication system supporting high-speed data communication are provided, which can reduce signaling overhead and increase system throughput by decreasing the size of the MAC header. A LEN unit of the MAC packet header is set to 1 byte when a TB size is less than or equal to a first predetermined threshold value. The LEN unit is set to 2 bytes when the TB size is greater than the first predetermined threshold value and is less than or equal to a second predetermined threshold value.

### PRIORITY

This application claims priority under 35 U.S.C. §119(a) to an application entitled “Apparatus and Method for Transmitting/Receiving MAC Header in Mobile Communication System” filed in the Korean Intellectual Property Office on Nov. 20, 2006, and assigned Serial No. 2006-0114775, the contents of which are incorporated herein by reference.

### BACKGROUND OF THE INVENTION

1. Field of the Invention

The present invention generally relates to an apparatus and method for transmitting/receiving a transmission header in a mobile communication system, and more particularly, to an apparatus and method for transmitting/receiving a Media Access Control (MAC) header in a mobile communication system.

2. Description of the Related Art

As is generally known in the art, a mobile communication system has been developed in order to provide a user with a voice service while ensuring mobility. With rapid development of technology, this mobile communication system has evolved into a form that can provide a data service. Such a mobile communication service capable of providing a data service is classified into a Code Division Multiple Access (CDMA) scheme, a Time Division Multiple Access (TDMA) scheme, and an Orthogonal Frequency Division Multiple Access (OFDMA) scheme according to its multiplexing scheme. The CDMA scheme has been much discussed in the 3GPP2 standard, and has entered a commercialization phase. Also, the TDMA scheme has been standardized in the Global System for Mobile communications (GSM) standard organization, and is providing commercialized services. In particular, since the GSM-based scheme has started in Europe, it is also called the European mobile communication scheme.

The Universal Mobile Telecommunication Service (UMTS) system is a 3^{rd} generation asynchronous mobile communication system that is based on GSM and General Packet Radio Services (GPRS) capable of ultra high-speed Internet and video communication, and employs a Wideband CDMA (WCDMA) scheme. The 3^{rd} Generation Partnership Project (3GPP) responsible for UMTS standardization is currently discussing Long Term Evolution (LTE) as an evolved mobile communication system of the UMTS system. LTE is technology for implementing high-speed packet-based communication of about 100 Mbps.

Before discussing LTE, it will be helpful to review the structure of UMTS. FIG. 1 illustrates the network structure of an evolved UMTS mobile communication system.

As illustrated in the drawing, an Evolved UMTS Radio Access Network (E-UTRAN or E-RAN) 110 has a simplified two node structure of an Evolved Node B (ENB) 120, 122, 124, 126, 128 and an anchor node 130, 132. A User Equipment (UE) 101 is connected to an Internet Protocol (IP) network via the E-UTRAN 110.

ENBs 120 to 128 correspond to an existing Node B of the UMTS system, and can provide the UE 101 with a voice service or a data service over a radio channel. Dissimilar to the existing Node B, ENBs 120 to 128 must perform more complex functions. In LTE, since all user traffic, including a pseudo real-time service over an IP, such as Voice over IP (VoIP), are serviced via a shared channel, an apparatus for collecting and scheduling situation information of UEs is required. Thus, in the E-UTRAN with the simplified two-node structure, ENBs 120 to 128 takes charge of such an operation.

Also, similar to a common Node B, one ENB controls a plurality of cells. Thus, in order to communicate with a UE, each ENB performs Adaptive Modulation and Coding (AMC) for determining a modulation scheme and a channel coding rate adaptive to the channel state of the UE. Therefore, each ENB can transmit/receive data to/from the UE through High Speed Downlink Packet Access (HSDPA), High Speed Uplink Packet Access (HSUPA) or an Enhanced-uplink Dedicated Channel (E-DCH), and can enhance the efficiency of data communication through a Hybrid Automatic Retransmission reQuest (HARQ) scheme between the ENB and the UE. Further, since various Quality of Service (QoS) requirements cannot be satisfied by such an HARQ scheme alone, an upper layer higher than a layer performing HARQ may use a separate ARQ (Outer-ARQ). The HARQ scheme refers to a technique for increasing a reception success rate by soft-combining previously received data with retransmitted data without discarding the previously received data, and is used for enhancing transmission efficiency in high-speed packet communication, such as HSDPA, E-DCH, etc. In order to enable a maximum transmission speed of 100 Mbps in communication between the ENB and the UE, LTE is expected to employ an OFDM scheme as radio access technology with a bandwidth of 20 MHz.

The structure of LTE corresponding to an evolved mobile communication system of UMTS is described with reference to FIG. 2. FIG. 2 illustrates a layer structure for data transmission and reception in LTE, which is an evolved UMTS mobile communication system.

In the LTE system, a plurality of application data may be transmitted. FIG. 2 shows an example in which a transmitter 210 transmits three different types of application data, that is, upper layer data 1 211a, upper layer data 2 211b, and upper layer data 3 211c. These different types of upper layer data 211a, 211b, 211c are input into Radio Link Control (RLC) transmission units 212a, 212b, 212c, respectively. That is, in the LTE system, one RLC transmission unit is provided for transmitting one type of upper layer data. All the RLC transmission units 212a, 212b, 212c have the same construction and perform the same operation, so only a discussion of the RLC transmission unit 212a that transmits upper layer data 1 211a is provided.

The RLC transmission unit 212a resizes upper layer data 1 211a to an appropriate size for transmission, and the resized data is called an RLC Packet Data Unit (PDU). When a receiving side requests retransmission of the RLC PDU, the RLC transmission unit 212a also performs an Automatic Retransmission reQuest (ARQ) operation in response to the retransmission request from the receiving side. In the present specification, an “RLC PDU” is used interchangeably with a “transmission data block” because the “RLC PDU” is a data block transmitted for each application service.

In the LTE system, each RLC transmission unit 212a, 212b, 212c constructs an RLC PDU 213 in such a manner as to have a size transmittable in a MAC layer at a point of time when it transmits each upper layer data 211a, 211b, 211c. Thus, the size of an RLC PDU output from each RLC transmission unit 212a, 212b, 212c may vary with a channel situation, a resource allocation situation or the like. A lower layer informs each RLC transmission unit 212a, 212b, 212c of the size of RLC PDU 213 to be transmitted in the next Transmission Time Interval (TTI). Each RLC transmission unit 212a, 212b, 212c then generates RLC PDU 213 by splitting or joining upper layer data according to the informed size and inserting an RLC PDU header. The RLC PDU header may include serial number information, etc.

A MAC transmission unit 214 multiplexes RLC PDUs 213 submitted from the RLC transmission units 212a, 212b, 212c to thereby generate a MAC PDU 215. Since RLC PDUs 213 generated by several RLC transmission units 212a, 212b, 212c may be multiplexed into one MAC PDU 215, multiplexing information for the RLC PDUs 213 is inserted into a MAC PDU header. The MAC PDU 215 generated in the MAC transmission unit 214 is processed according to the HARQ scheme, and is transmitted to the receiving side over a radio channel. Processing according to the HARQ scheme may be generally a modulation and coding process.

In this process, a packet actually transmitted over a radio channel is also called a Transport Block (TB) 241. As a matter of fact, since one MAC PDU 215 is mapped to one TB 241, the terms “MAC PDU” and “TB” can be considered terms designating the same object. Thus, in the following description, these two terms will be used in the same sense.

For an HARQ operation, information necessary for decoding a TB 241 is transmitted together with a separate control signal when the TB 241 is transmitted from an HARQ transmission unit 216. This information includes information indicating the size of a TB (TB size) 232, information on a Modulation and Coding Scheme (MCS) applied to the TB (MCS Information) 231, and so forth. Since the TB 241 and the MAC PDU 215 designate the same object, as mentioned above, the information indicating a TB size 232 is not different from information indicating the length of the MAC PDU 215.

The transmitter 210 with the aforementioned structure transmits the TB 241 over a traffic channel 240 and the control signal over a control channel to a receiver 220 for providing information for decoding of the TB 241. Hereinafter, a description will be given of the structure and operation for receiving and processing the TB 241 in the receiver 220.

Upon successfully receiving the TB 241, an HARQ reception unit 221 performs demodulation and decoding, and transmits a response signal to the transmitter 210 over a response channel 250. That is, the HARQ reception unit 221 transmits an ACK signal 251 over the response channel 250 if succeeding in decoding the received TB 241, and transmits an NACK signal 251 over the response channel 250 if failing in decoding the received TB 241. On successfully decoding the received TB 241, the HARQ reception unit 221 forwards a decoded MAC PDU 222 to a MAC reception unit 223. The MAC reception unit 223 then separates an RLC PDU/RLC PDUs 224 from the MAC PDU 222 using header information of the MAC PDU 222, and forwards the separated RLC PDU(s) 224 to an appropriate RLC reception unit 225a, 225b, 225c. Each RLC reception unit 225a, 22b, 22c then generates and outputs upper layer data 226a, 226b, 226c that is identical to application data on the transmitting side. As discussed above, one of the important operations of a MAC layer is to multiplex RLC PDUs generated by several RLC transmission units into one MAC PDU, and to demultiplex the RLC PDUs from the MAC PDU.

FIG. 3 illustrates the structure of a MAC PDU. Hereinafter, the structure of a MAC PDU will be described with reference to FIG. 3.

Upon receiving an RLC PDU 213 from an RLC transmission unit, the MAC transmission unit 214 inserts the Logical Channel ID (LID) 301, 303 of the RLC transmission unit and the Length (LEN) 302, 304 of the received RLC PDU into a MAC header. Since one LID and one LEN per RLC PDU are inserted into the MAC header, as many LIDs and LENs as RLC PDUs are inserted when a plurality of RLC PDUs 305, 306 are multiplexed into one MAC PDU. Since information of the MAC header is generally located in the front of a MAC PDU, LIDs and LENs within the MAC header match to RLC PDUs within a MAC SDU (Service Data Unit) in their order. In other words, the first LID 301 and the first LEN 302 within the MAC header are information regarding the first RLC PDU 305, and the second LID 303 and the second LEN 304 are information regarding the second RLC PDU 306.

For a physical layer operation, the overall length of a MAC PDU is provided to a receiving side as separate control information, which is referred to as a TB size. Since the TB size is a value quantized according to given criteria, padding 307 in the MAC layer may also be used in some cases.

In the UMTS system, since several RLC PDUs are not multiplexed into one MAC PDU, but only one RLC PDU is mapped to one MAC PDU, it is not necessary to insert a separate LEN field into a MAC header, in addition to a TB size as control information. However, as mentioned above, RLC PDUs generated in several RLC transmission units are multiplexed into one MAC PDU in the LTE system, and thus it is necessary to insert information on the lengths of the respective RLC PDUs into a MAC header. Also, the LTE system providing a high-speed data transmission service uses a TTI of 0.5 ms, and targets a data transfer rate of 100 Mbps. This means that 50000 bits are transmitted per TTI, so the LTE system is expected to use a TB size of 6250 bytes (50000/8).

When one RLC PDU is multiplexed into one MAC PDU, a LEN field of a MAC PDU must be able to express a TB size with a maximum of 6250 bytes. In order to express such a TB size value, the LEN field requires at least 13 bits. In general, however, a plurality of RLC PDUs is multiplexed into one MAC PDU. Thus, if a plurality of LEN fields is allocated 13 bits respectively, signaling overhead may occur. Also, such an overhead increase may result in lowering of the overall system throughput.

### SUMMARY OF THE INVENTION

The present invention has been made to address at least the above problems and/or disadvantages and to provide at least the advantages described below. Accordingly, an aspect of the present invention provides an apparatus and method for reducing signaling overhead in a system supporting high-speed data communication.

Another aspect of the present invention provides an apparatus and method for reducing the length of a transmission header in a system supporting high-speed data communication.

An additional aspect of the present invention provides an apparatus and method for enhancing throughput in a system supporting high-speed data communication.

A further aspect of the present invention provides an apparatus and method for reducing a header of packet data in an LTE system.

An additional further aspect of the present invention provides an apparatus and method for reducing signaling overhead in an LTE system.

According to one aspect of the present invention, a method of setting a Media Access Control (MAC) packet header when a MAC packet is transmitted in a mobile communication system is provided. A LEN unit of the MAC packet header is set to 1 byte when a Transport Block (TB) size is not greater than a first predetermined threshold value. The LEN unit is set to 2 bytes when the TB size is greater than the first predetermined threshold value and is not greater than a second predetermined threshold value.

According to another aspect of the present invention, a method of interpreting a MAC packet header when a MAC packet is received in a mobile communication system where size information of a TB transmitted over a traffic channel is provided over a control channel is provided. The size information of the TB is received over the control channel. A LEN field of the MAC packet header is interpreted at face value when the received size information is not greater than a first predetermined threshold value. The LEN field of the MAC packet header is interpreted as indicating a size that is as twice as large as a LEN field value when the received size information is greater than the first predetermined threshold value and is not greater than a second predetermined threshold value.

According to a further aspect of the present invention, an apparatus for setting a MAC packet header when a MAC packet is transmitted in a mobile communication system is provided. The apparatus includes at least one Radio Link Control (RLC) transmission unit for splitting application data received from an upper layer into transport data blocks with a size transmittable over a traffic channel, and outputting the split data blocks. The apparatus also includes a data construction unit for generating a TB to be transmitted over the traffic channel by joining the transport data blocks. The apparatus includes a control unit for setting a LEN unit of a header of the TB to 1 byte when a TB size is not greater than a first predetermined threshold value, and setting the LEN unit of the header of the TB to 2 bytes when the TB size is greater than the first predetermined threshold value and is not greater than a second predetermined second threshold value. The apparatus further includes a header insertion unit for inserting the header, the LEN unit of which has been set.

According to yet another aspect of the present invention, an apparatus for interpreting a MAC packet header when a MAC packet is received in a mobile communication system where size information of a TB transmitted over a traffic channel is provided over a control channel is provided. The apparatus includes a control channel processing unit for checking the size information of the TB, received over the control channel, to thereby detect a TB size, interpreting a LEN field of the MAC packet header at face value when the TB size is not greater than a first predetermined threshold value, and interpreting the LEN field of the MAC packet header as indicating a size twice that is as large as a LEN field value when the TB size is greater than the first predetermined threshold value and is not greater than a second predetermined threshold value. The apparatus also includes a MAC packet header interpretation unit for interpreting the MAC packet header under the control of the control channel processing unit. The apparatus further includes a data separation unit for separately outputting transport data blocks of the MAC packet by using interpretation information forwarded from the MAC packet header interpretation unit.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating a network structure of an evolved UMTS mobile communication system;

FIG. 2 is a diagram illustrating a layer structure for transmitting/receiving data in LTE, which is an evolved UMTS mobile communication system;

FIG. 3 is a diagram illustrating a structure of an MAC PDU;

FIG. 4 is a block diagram illustrating a structure of a transmitter for generating and transmitting a MAC PDU in accordance with an embodiment of the present invention;

FIG. 5 is a block diagram illustrating a structure of a receiver for receiving and interpreting a MAC PDU in accordance with an embodiment of the present invention;

FIG. 6 is a graph for setting and interpreting an RLC PDU length using a LEN unit in accordance with an embodiment of the present invention;

FIG. 7 is a control flowchart for generating a MAC PDU in a transmitter in accordance with an embodiment of the present invention;

FIG. 8 is a flowchart for interpreting a MAC PDU in a receiver in accordance with an embodiment of the present invention;

FIG. 9A is a graph for setting and interpreting a field for indicating an RLC PDU length in accordance with an embodiment of the present invention;

FIG. 9B is a graph for setting and interpreting a field for indicating an RLC PDU length in accordance with an embodiment of the present invention;

FIG. 10 is a flowchart for setting an RLC PDU in a transmitter in accordance with an embodiment of the present invention;

FIG. 11 is a flowchart for interpreting an RLC PDU in a receiver in accordance with an embodiment of the present invention; and

FIGS. 12A to 12C are diagrams illustrating the overall structure of a MAC PDU in accordance with an embodiment of the present invention.

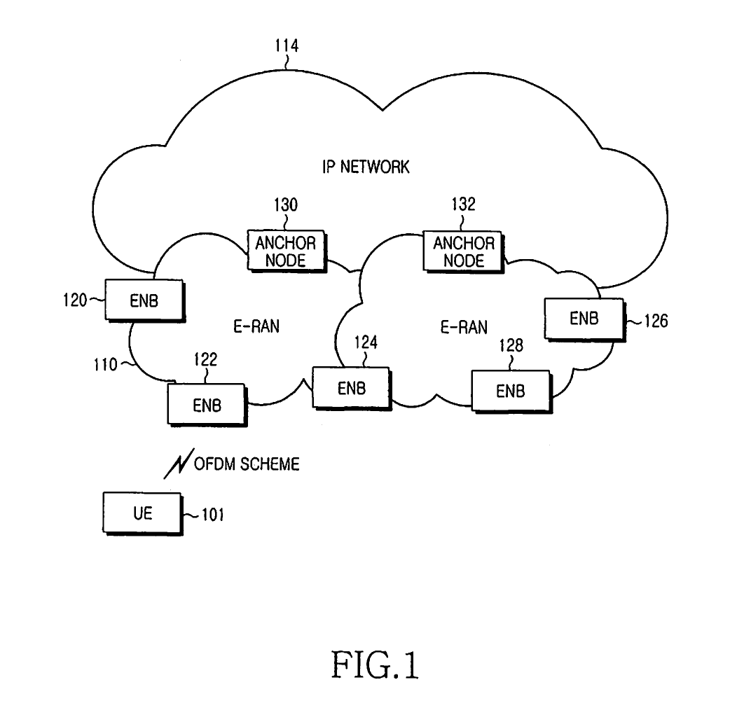

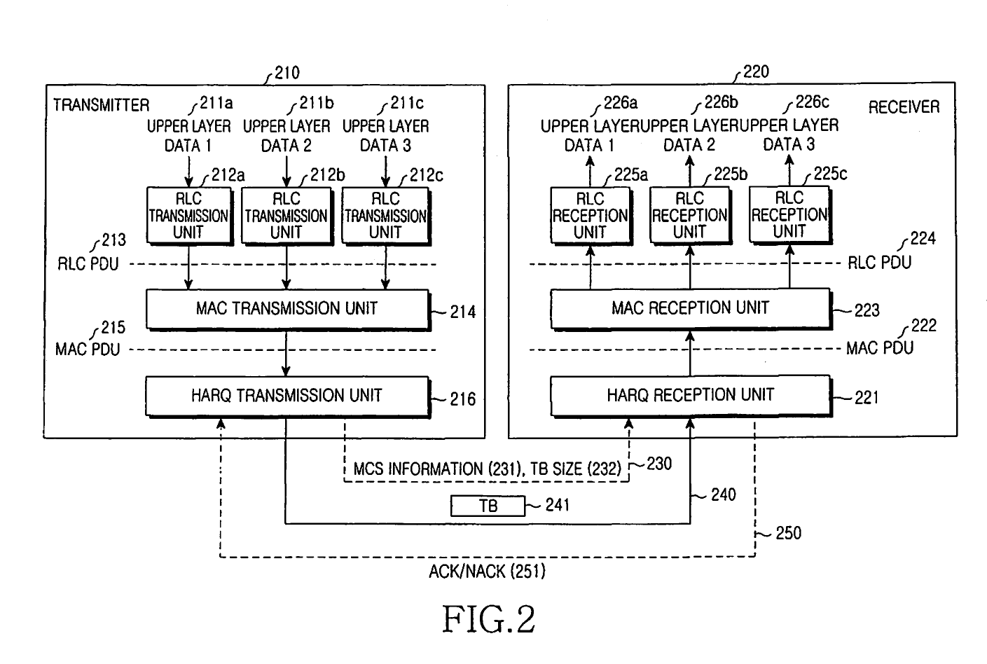

### DETAILED DESCRIPTION OF THE PREFERRED EMBODIMENTS

Preferred embodiments of the present invention are described in detail with reference to the accompanying drawings. It should be noted that the similar components are designated by similar reference numerals although they are illustrated in different drawings. Detailed descriptions of constructions or processes known in the art may be omitted to avoid obscuring the subject matter of the present invention.

Each embodiment of the present invention, as described below, proposes a method and apparatus in which when a LEN field for indicating the length of an RLC PDU in a MAC header has a limited size, the length of the RLC PDU can be efficiently indicated using the limitative LEN field. In the following embodiments of the present invention, it is assumed that the LEN field for indicating the length of an RLC PDU has a basic size of 11 bits. It should be noted that the actual length may vary according to the respective embodiments. Further, it is assumed that the maximum length of an RLC PDU or MAC PDU is 6250 bytes. Of course, the length of the RLC PDU or MAC PDU may also vary according to systems to which the present invention is applied.

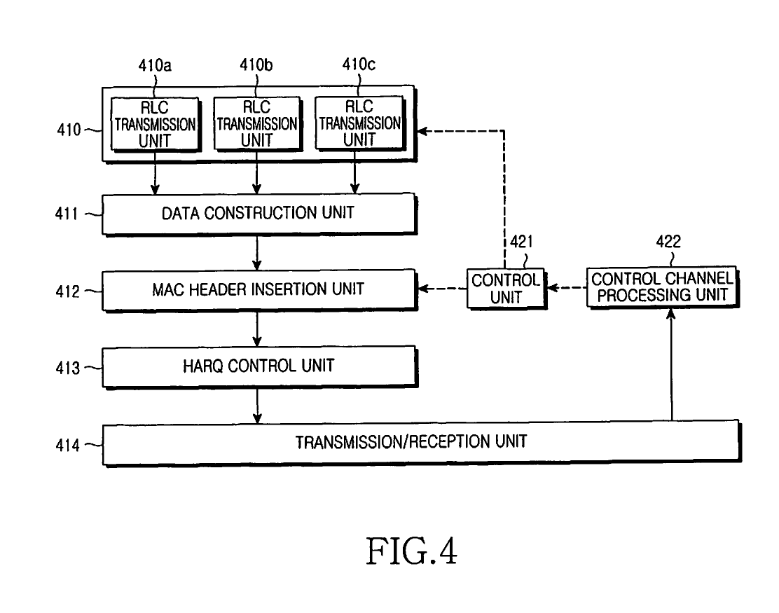

FIG. 4 illustrates the structure of a transmitter for generating a MAC PDU according to an embodiment of the present invention.

RLC transmission units 410a, 410b, 410c belonging to an RLC layer 410 of the transmitter according to the present invention generate RLC PDUs by splitting a data stream of data received from an upper layer in such a manner as to match to a transmission packet size, and then outputs the generated RLC PDUs to a data construction unit 411. The number of the RLC transmission units 410a, 410b, 410c may vary according to the number of application services to be transmitted. Each of the RLC transmission units 401a, 410b, 410c sets the length of the RLC PDU under the control of a control unit 421 to be described below, and splits the upper layer data according to the set length and outputs the RLC PDU generated in this way.

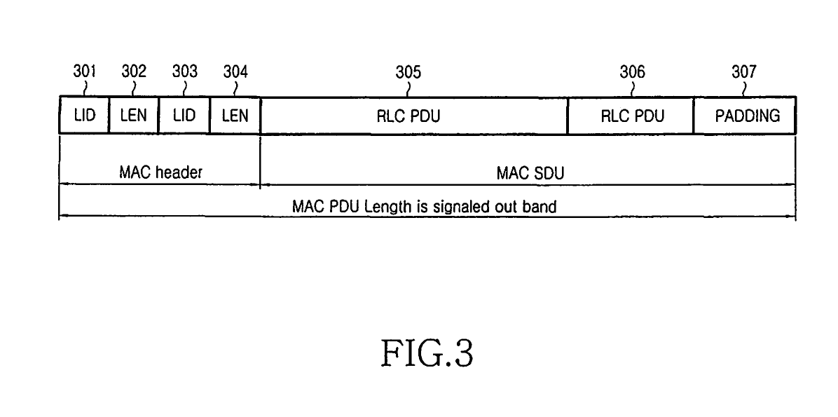

The data construction unit 411 and a MAC header insertion unit 412 belong to a MAC layer, and correspond to the MAC transmission unit. The data construction unit 411 joins or splits the RLC PDUs received from the RLC transmission units 410a, 410b, 410c, so as to construct a MAC PDU. The MAC header insertion unit 412 inserts a MAC header into the joined or split data to thereby generate a MAC PDU, and outputs the generated MAC PDU. The MAC header is inserted in a different manner according to each embodiment of the present invention described below, and as a result a MAC PDU as described in FIG. 3 is output.

In an HARQ control unit 413, the MAC PDU with the MAC header inserted as described above is subjected to processing necessary for an HARQ operation, and the processed MAC PDU is output to a transmission/reception unit 414. The processing necessary for an HARQ operation may be CRC addition, coding, modulation and the like. Subsequently, the transmission/reception unit 414 converts a coded and modulated signal into a signal of a transmission band set in a mobile communication system, which is in turn transmitted on-air, and down-converts a signal received on-air to a low band.

Among such down-converted signals, a control channel signal is input into a control channel processing unit 422. The control channel processing unit 422 demodulates and/or decodes the received control channel signal, and outputs the demodulated and/or decoded signal to the control unit 421. When a transmission resource is allocated through a control channel or the size of data to be transmitted over a data channel is determined as a result of scheduling, the control unit 421 determines which RLC transmission unit to activate by considering the priorities of application services to be transmitted through the RLC transmission units 410a, 410b, 410c, and determines the length of an RLC PDU. Length information of the RLC PDU, determined in this way, is provided to the corresponding RLC transmission unit and the MAC header insertion unit 412, where the length of an RLC PDU is determined based on the length information, and a MAC header to be applied according to the present invention is set. The control unit 421 determines the length of a MAC PDU to be transmitted, determines how to set a LEN field in the MAC header by considering the length of RLC PDUs, the length of a MAC PDU, and the size of a TB, and forwards information on them to the MAC header insertion unit 412.

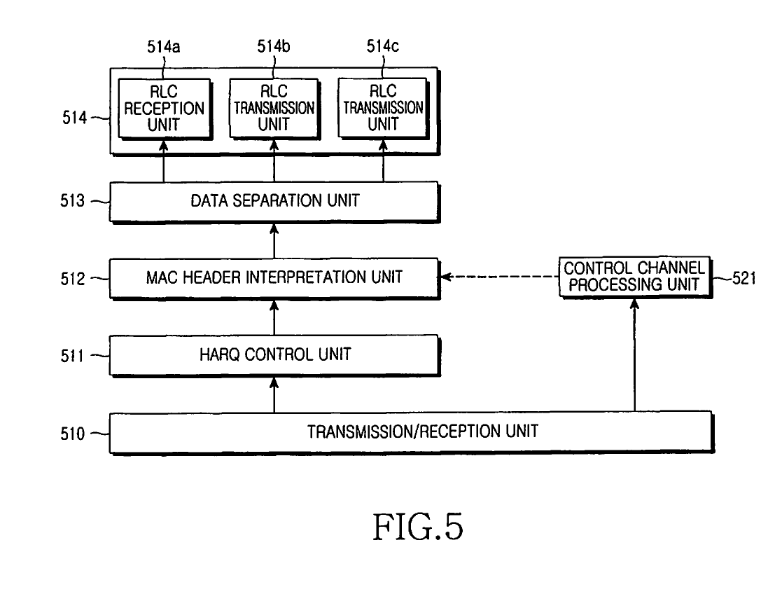

FIG. 5 illustrates the structure of a receiver for receiving and interpreting a MAC PDU according to an embodiment of the present invention.

The signal transmitted as mentioned above is input into a transmission/reception unit 510. The transmission/reception unit 510 receives a signal forwarded on-air, down-converts the received signal to a low band, and then outputs the down-converted signal. Data of the output signal, which is received over a traffic channel, is input into an HARQ control unit 511, and data received over a control channel is input into a control channel processing unit 521. Also, the transmission/reception unit 510 down-converts a response signal to be transmitted to a transmitter to a low band, and then transmits the down-converted response signal on-air. The HARQ control unit 511 demodulates and decodes the down-converted signal received from the transmission/reception unit 510, perform CRC check, and then outputs a result of the CRC check to a MAC header interpretation unit 512 when the result is good.

The control channel processing unit 521 demodulates and/or decodes the data received over the control channel, interprets MCS information of transmitted traffic, information on a TB size, etc., generates information for interpreting a MAC header according to the present invention, based on the interpreted information, and then provides the MAC header interpretation unit 512 with the generated information. Such information for interpreting a MAC header is described in detail in each embodiment of the present invention. Also, in the following description, the information for interpreting a MAC header according to each embodiment of the present invention will be referred to as “MAC header interpretation information”.

The MAC header interpretation unit 512 interprets a LEN field, included in the header of a received RLC PDU, by using the MAC header interpretation information received from the control channel processing unit 521, and outputs information on the header interpreted in this way, information on the interpreted LEN field, and a data field from which the header is separated to a data separation unit 513. The data separation unit 513 then separates RLC PDUs included in a MAC Service Data Unit (SDU) of a MAC PDU, and outputs the separated RLC PDUs to an RLC layer 514. The RLC PDUs separated in this way are processed by RLC reception units 514a, 514b, 514c for RLC PDU processing, and are forwarded to an upper layer.

Reference will now be made in detail to a method of setting and interpreting a MAC header in the above-mentioned apparatuses according to embodiments of the present invention.

A first embodiment of the present invention proposes a method of differently setting and interpreting the unit of bits of a LEN field included in a MAC header according to a TB size transmitted over a different channel, that is, the control channel 230.

As mentioned above, a TB size is transmitted to a receiver over a separate control channel. Thus, the receiver can process a MAC PDU after identifying the TB size received over the control channel. For the convenience of explanation, terms are defined as follows:

(1) TB_SIZE: Length of any MAC PDU transmitted over a separate channel.

(2) MAX_RLC_PDU_SIZE: Maximum value that an RLC PDU can represent. In the first embodiment of the present invention, a maximum value varies by diversifying setting and interpretation of this value. Basically, the maximum length of an RLC PDU is 2047 (2¹¹−1) bytes if a LEN field has a size of 11 bits, and is 1023 (2¹⁰−1) bytes if a LEN field has a size of 10 bits.

In the first embodiment of the present invention, the unit of setting and interpreting respective bits of a LEN field is determined as follows:

First, if TB_SIZE is not greater than MAX_RLC_PDU_SIZE, the unit of setting and interpreting respective bits of a LEN field is 1 byte. Second, if TB_SIZE is greater than MAX_RLC_PDU_SIZE and is not greater than double MAX_RLC_PDU_SIZE, the unit of setting and interpreting respective bits of a LEN field is 2 bytes. Third, if TB_SIZE is greater than double MAX_RLC_PDU_SIZE and is not greater than quadruple MAX_RLC_PDU_SIZE, the unit of setting and interpreting respective bits of a LEN field is 4 bytes. Fourth, if TB_SIZE is greater than quadruple MAX_RLC_PDU_SIZE and is not greater than octuple MAX_RLC_PDU_SIZE, the unit of setting and interpreting respective bits of a LEN field is 8 bytes. In this way, this setting and interpretation method can continually extend. In the following description, the unit of respective bits of a LEN field will be referred to as a LEN unit.

Hereinafter, a method of setting and interpreting a LEN unit in the above-mentioned manner when the length of a LEN field is 11 bits will be described by way of example.

The first case mentioned above corresponds to a case where a TB size is not greater than 2047, and a LEN unit means 1 byte. The second case mentioned above corresponds to a case where a TB size is greater than 2047 and is not greater than 4095, and a LEN unit means 2 bytes. The third case mentioned above corresponds to a case where a TB size is greater than 4095, and a LEN unit means 4 bytes. The final case mentioned above corresponds to a case where a TB size is greater than 8191, and a LEN unit means 8 bytes.

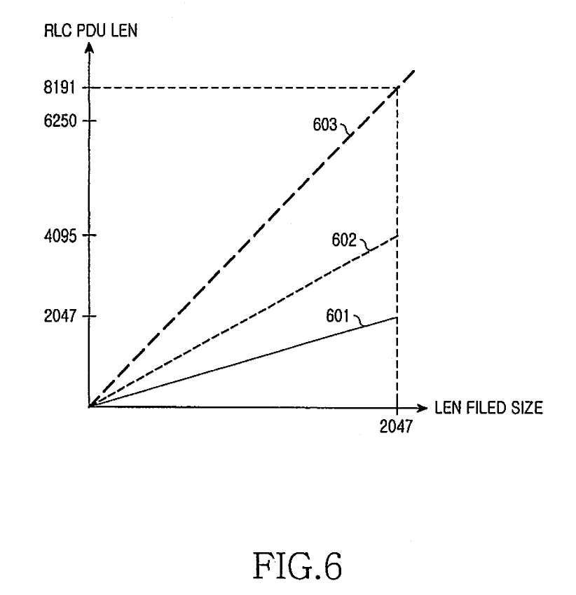

The first embodiment of the present invention is illustrated in FIG. 6 that illustrates a graph for setting and interpreting an RLC PDU length by using a LEN unit.

Referring to FIG. 6, when a LEN unit of 1 byte is used, an RLC PDU length expressible by the LEN unit ranges from 0 to 2047, as seen from a curve 601. When a LEN unit is defined as 2 bytes, an RLC PDU length expressible by the LEN unit ranges from 0 to 4095, as seen from a curve 602. Here, the length value of an RLC PDU may be expressed by multiples of 2, such as 0, 2, 4, 6, . . . , 4094. When a LEN unit is defined as 4 bytes, an RLC PDU length expressible by the LEN unit ranges from 0 to 8191, as seen from a curve 603. Here, the length value of an RLC PDU may be expressed by multiples of 4, such as 0, 4, 8, 12, . . . , 8188.

If a LEN unit is defined as a value of 2 bytes or greater, as in the first embodiment of the present invention, all values falling within a corresponding range cannot be expressed. In such a case, an RLC transmission unit of a transmitter adds padding corresponding to the amount of shortage when generating an RLC PDU, so that the RLC PDU is generated with a size expressible by the LEN unit. The structure of a transmitter performing such an operation will be described below with reference to the accompanying drawings.

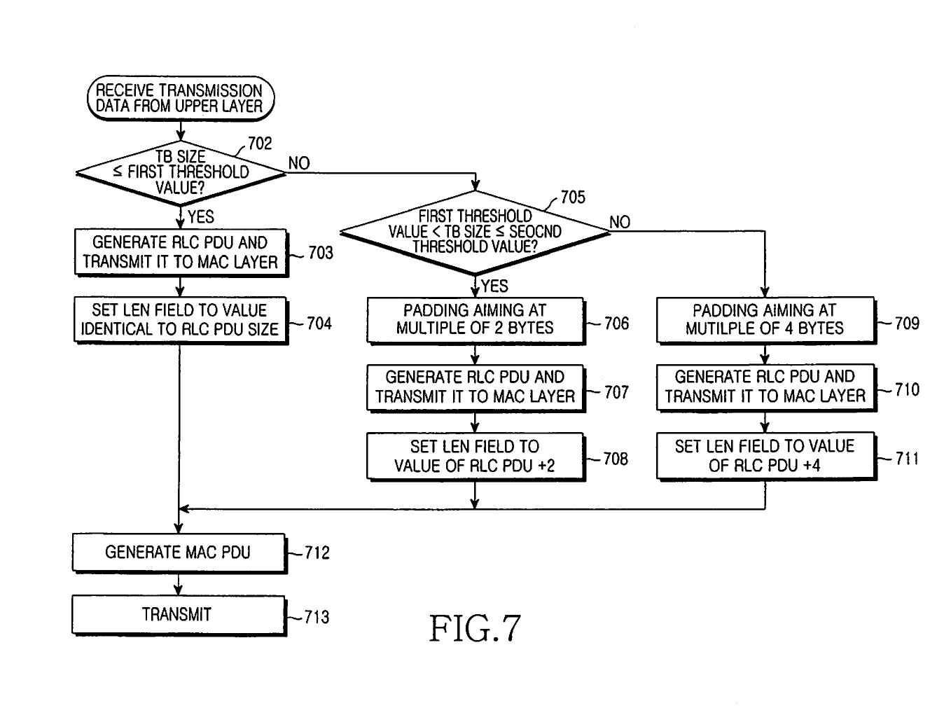

FIG. 7 illustrates a control flowchart for generating a MAC PDU in a transmitter according to the first embodiment of the present invention. It should be noted that a procedure illustrated in FIG. 7 is a routine performed whenever data to be transmitted is received from an upper layer.

On receiving transmission data from an upper layer, the RLC transmission units 410a, 410b, 410c splits or joins the transmission data based on control information received from the control unit 421, and outputs the split or joined data. In order to split or join the transmission data, each RLC transmission unit 410a, 410b, 410c proceeds to step 702, and checks if the size of a TB to be transmitted is equal to or less than a first threshold value. If a result of the checking in step 702 shows that the TB size is equal to or less than the first threshold value, the RLC transmission unit proceeds to step 703, and otherwise proceeds to step 705. In step 705, the RLC transmission unit checks if the TB size is greater than the first threshold value and is not greater than a second threshold value. If a result of the checking in step 705 shows that the TB size is greater than the first threshold value and is not greater than the second threshold value, the RLC transmission unit proceeds to step 706, and otherwise proceeds to step 709. Here, the first threshold value may be a TB size of 2047, and the second threshold value may be a TB size of 4095, as mentioned above.

The case where the RLC transmission unit proceeds from step 702 to step 703 is a common case. Thus, each RLC transmission unit 410a, 410b, 410c generates an RLC PDU based on the control information received from the control unit 421, and outputs the generated RLC PDU to the data construction unit 411. The data construction unit 411 then receives RLC PDUs from the respective RLC transmission units 410a, 410b, 410c, constructs data by joining the RLC PDUs, the number of which corresponds to the size of a TB to be transmitted, and then outputs the constructed data to the MAC header insertion unit 412. The MAC header insertion unit 412 then generates a MAC header corresponding to the length of the RLC PDU in step 704. Here, generating the MAC header is to create an LID corresponding to the RLC PDU and set a LEN field according to the length of the RLC PDU. Since this case is a case where the TB size is within a range that can be expressed by a given number of bits of the field, the LEN field is determined in such a manner as to match to the length of the RLC PDU.

Further, after the MAC header insertion unit 412 generates the MAC headers, it proceeds to step 712, and generates a MAC PDU by inserting the MAC headers into the data and combining the MAC headers and the data. Subsequently, in step 713, the generated MAC PDU is transmitted through the HARQ control unit 413 and the transmission/reception unit 414.

The case where the RLC transmission unit proceeds from step 705 to step 706 is a case where the TB size is greater than the first threshold value of a length expressible by the LEN field and is less than the second threshold value. That is, the whole length cannot be expressed. This case may be represented by the curve 602 of FIG. 6. Thus, on proceeding to step 706, each RLC transmission 410a, 410b, 410c performs padding with zeros (0) such that the length of an RLC PDU is a multiple of 2 bytes. In this way, it becomes possible to express the length of an RLC PDU. Subsequently, each RLC transmission unit 410a, 410b, 410c proceeds to step 707, generates an RLC PDU by using the padded information, and then provides the generated RLC PDU to the data construction unit 411. The data construction unit 411 then receives RLC PDUs from the respective RLC transmission units 410a, 410b, 410c, and generates a MAC Service Data Unit (SDU) by joining the RLC PDUs. Subsequently, in step 708, the MAC header insertion unit 412 generates a MAC header. Here, the MAC header to be inserted into the MAC SDU consists of an LID for identifying an RLC PDU within the MAC SDU and information on the length of the RLC PDU. Here, since the length of the RLC PDU may be represented by the curve 602 of FIG. 6, as mentioned above, a LEN field is set to a value corresponding to the length of the RLC PDU divided by 2.

Once MAC headers are generated in this way, the MAC header insertion unit 412 proceeds to step 712, and generates a MAC PDU by inserting the generated MAC headers into the MAC SDU. Subsequently, in step 713, the generated MAC PDU is transmitted through the HARQ control unit 413 and the transmission/reception unit 414.

Finally, the case where the RLC transmission unit proceeds from step 705 to step 709 is a case where the TB size is greater than the second threshold value of a length expressible by the LEN field. That is, similar to the preceding case, the whole length cannot be expressed. This case may be represented by the curve 603 of FIG. 6. Thus, on proceeding to step 709, each RLC transmission 410a, 410b, 410c performs padding with zeros (0) such that the length of an RLC PDU is a multiple of 4 bytes. In this way, it becomes possible to express the length of an RLC PDU. Subsequently, each RLC transmission unit 410a, 410b, 410c proceeds to step 710, generates an RLC PDU by using the padded information, and then provides the generated RLC PDU to the data construction unit 411. The data construction unit 411 then receives RLC PDUs from the respective RLC transmission units 410a, 410b, 410c, and generates a MAC SDU by joining the RLC PDUs. Subsequently, in step 711, the MAC header insertion unit 412 generates a MAC header. Here, the MAC header to be inserted into the MAC SDU consists of an LID for identifying an RLC PDU within the MAC SDU and information on the length of the RLC PDU. Here, since the length of the RLC PDU may be represented by the curve 603 of FIG. 6, as mentioned above, a LEN field is set to a value corresponding to the length of the RLC PDU divided by 4.

Once MAC headers are generated in this way, the MAC header insertion unit 412 proceeds to step 712, and generates a MAC PDU by inserting the generated MAC headers into the MAC SDU. Subsequently, in step 713, the generated MAC PDU is transmitted through the HARQ control unit 413 and the transmission/reception unit 414.

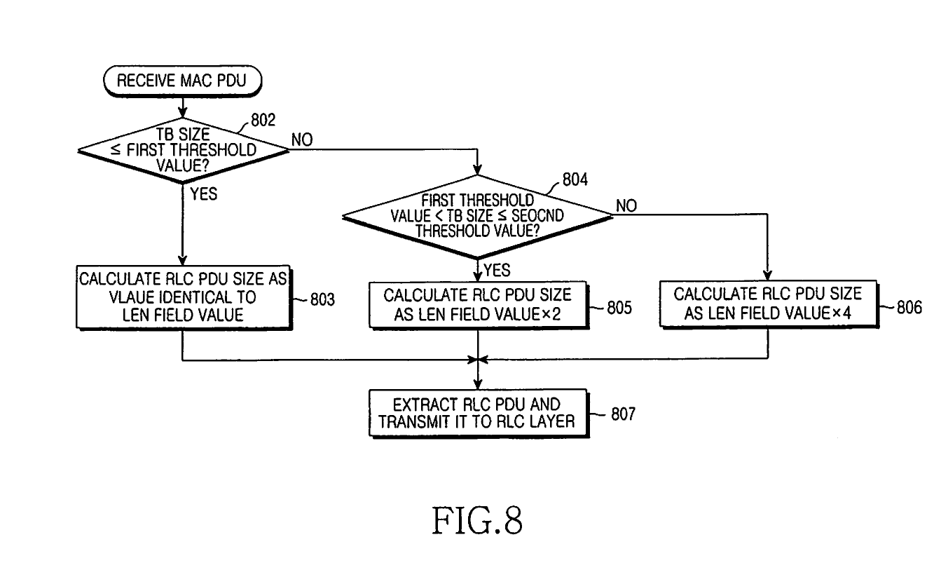

FIG. 8 illustrates a control flowchart for interpreting a MAC PDU according to the first embodiment of the present invention. It should be noted that a procedure illustrated in FIG. 8 is a routine performed whenever data is received in each TTI.

On receiving an on-air transmitted MAC PDU through the transmission/reception unit 510 and the HARQ control unit 511, the control channel processing unit 521 proceeds to step 802, and checks if a TB size is equal to or less than a first threshold value. If a result of the checking in step 802 shows that the TB size is equal to or less than the first threshold value, the control channel processing unit 521 proceeds to step 803, and otherwise proceeds to step 804. In step 804, the control channel processing unit 521 checks if the TB size is greater than the first threshold value and is not greater than a second threshold value. If a result of the checking in step 804 shows that the TB size is greater than the first threshold value and is not greater than the second threshold value, the control channel processing unit proceeds to step 805, and otherwise proceeds to step 806.

The case where the control channel processing unit 521 proceeds from step 802 to step 803 is a case where the whole length can be expressed by a LEN field included in the header of the MAC PDU. On proceeding to step 803, the MAC header interpretation unit 512 receives TB size information from the control channel processing unit 521, interprets a LEN field included in the MAC PDU at face value. That is, the value of a LEN field corresponding to an RLC PDU is interpreted as indicated by the LEN field. This is the same case as in the prior art. Thus, the MAC header interpretation unit 512 forwards the value, interpreted as the length of an RLC PDU in this way, to the data separation unit 513. The data separation value 513 then proceeds to step 807, separates RLC PDUs from the MAC PDU based on the header information interpreted in step 803, and then forwards the separated RLC PDUs to the RLC layer 514. The respective RLC PDUs are input into and processed by the RLC reception units 514a, 514b, 514c.

Next, the case where the control channel processing unit 521 proceeds from step 804 to step 805 is a case where the whole length of an RLC PDU cannot be expressed by a LEN field. Thus, in the first embodiment of the present invention, when the TB size is greater than the first threshold value and is not greater than the second threshold value, the value of a LEN field for indicating the length of an RLC PDU, included in a MAC header, is set to a value, the double of which corresponds to the actual length of an RLC PDU. Therefore, based on information received from the control channel processing unit 521, the MAC header interpretation unit 512 interprets the length of an RLC PDU as the double of the value of the LEN field included in the MAC header. That is, in calculating the length of an RLC PDU, the length is calculated by multiplying the value received through the LEN field by 2. After the MAC header interpretation unit 512 interprets the length of an RLC PDU in this way, it provides the data separation unit 513 with the interpreted size information of RLC PDU. The data separation unit 513 then proceeds to step 807, separates RLC PDUs from the MAC PDU based on the header information interpreted in step 805, and then forwards the separated RLC PDUs to the RLC layer 514. The respective RLC PDUs are input into and processed by the RLC reception units 514a, 514b, 514c.

Finally, the case where the control channel processing unit 521 proceeds from step 804 to step 806 is also a case where the whole length of an RLC PDU cannot be expressed by a LEN field. Thus, in the first embodiment of the present invention, when the TB size is greater than the second threshold value, the value of a LEN field for indicating the length of an RLC PDU, included in a MAC header, is set to a value, the quadruple of which corresponds to the actual length of an RLC PDU. Therefore, based on information received from the control channel processing unit 521, the MAC header interpretation unit 512 interprets the length of an RLC PDU as the quadruple of the value of the LEN field included in the MAC header. That is, in calculating the length of an RLC PDU, the length is calculated by multiplying the value received through the LEN field by 4. After the MAC header interpretation unit 512 interprets the length of an RLC PDU in this way, it provides the data separation unit 513 with the interpreted size information of RLC PDU. The data separation unit 513 then proceeds to step 807, separates RLC PDUs from the MAC PDU based on the header information interpreted in step 806, and then forwards the separated RLC PDUs to the RLC layer 514. The respective RLC PDUs are input into and processed by the RLC reception units 514a, 514b, 514c.

In this way, even when the length of an RLC PDU to be transmitted increases, data can be expressed without increasing the size of a MAC header. Accordingly, there are advantages in that the overall system throughput can be improved, and system overhead can be reduced.

A second embodiment of the present invention proposes a method of setting and interpreting a LEN unit in a different manner according to the value of a LEN field included in a MAC header. Hereinafter, one way to implement the second embodiment of the present invention will be discussed.

Firstly, when a LEN field has a value of 0 to N1, an RLC PDU size mapped to a corresponding value increases by 1 byte as the value of the LEN field increases. That is, the length of an RLC PDU is set and interpreted as indicated by the LEN field. Secondly, when a LEN field has a value of N1 to N2, an RLC PDU size mapped to a corresponding value increases by 2 bytes as the value of the LEN field increases. That is, for a value following N1, the length of an RLC PDU is set and interpreted as the double of the value indicated by the LEN field. Finally, when a LEN field has a value of N2 to 2047, an RLC PDU size mapped to a corresponding value increases by 4 bytes as the value of the LEN field increases. That is, for a value following N2 greater than N1, the length of an RLC PDU is set and interpreted as the quadruple of the value indicated by the LEN field. In such a case, the overall packet size is also changed. That is, the overall size of a packet may vary according to whether a MAC packet to be transmitted consists of only RLC PUDs expressible by values of N1 or less, RLC PDUs expressible by values greater than N1 and not greater than N2, or RLC PDUs expressible by values greater than N2. Thus, based on this size value of a MAC packet, it is possible to identify whether a value received over a control channel has a value of only up to N1, a value of up to N2, or a value greater than N2. However, such a method need not be necessarily used because interpretation is possible using only a MAC header.

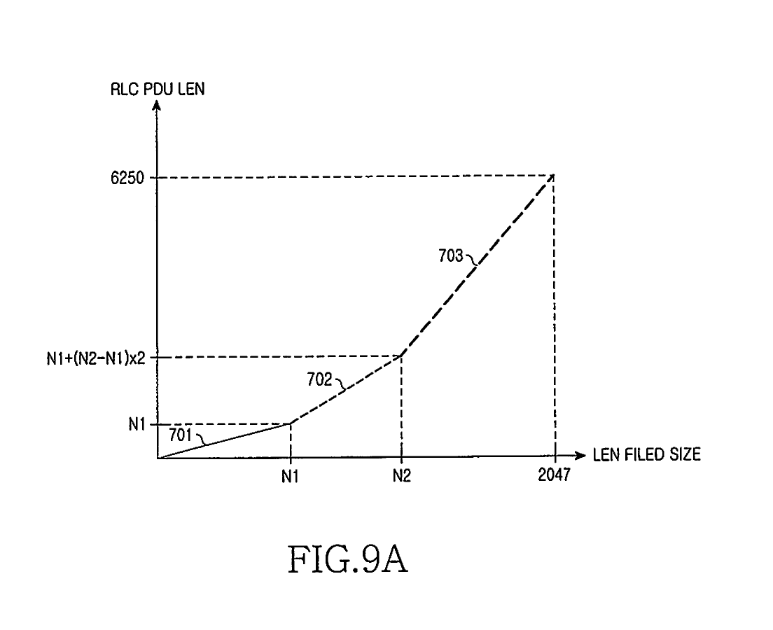

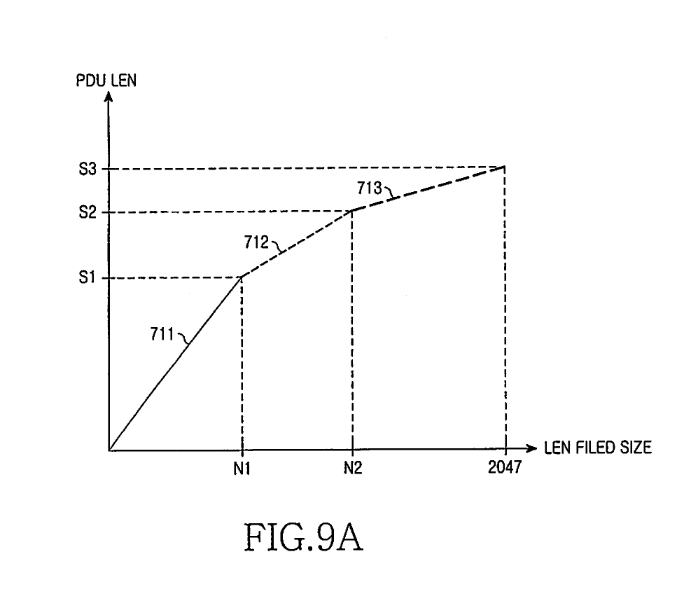

FIG. 9A illustrates a graph for setting and interpreting a field for indicating the length of an RLC PDU according to a first example of the second embodiment of the present invention.

In FIG. 9A, it is assumed that the maximum length of an RLC PDU to be expressed by a LEN field is 6259 bytes. When the value of a LEN field ranges from 0 to N1, the meaning of a LEN unit is interpreted as 1 byte, as designated by a curve 701. In such a case, the length of an RLC PDU that can be expressed by a LEN field covers all values of 0 to N1. When the value of a LEN field ranges from N1 to N2, the meaning of a LEN unit is interpreted as 2 bytes, as designated by a curve 702. In such a case, the length of an RLC PDU is expressed by Equation (1):

N1+2×(N2−N1) (1)

Also, values that can be expressed within a range of N1 to N2 are as Equation (2):

N1,N1+2,N1+4, . . . , N1+{2×(N2−N1)} (2)

That is, if N1 is equal to 0, values increasing by 2, such as 0, 2, 4, 6, . . . , 4094, can be expressed. Further, when the value of a LEN field ranges from N2 to 2047, the meaning of a LEN unit is interpreted as 4 bytes, as designated by a curve 703. In such a case, the length of an RLC PDU is interpreted as the quadruple of the LEN field value within a range of N1+(2×(N2−N1)) to 6250, and its expressible range is given by Equation (3):

N1+(2×(N2−N1)),N1+(2×(N2−N1))+4,N1+(2×(N2−N1))+8, . . . , 6250 (3)

That is, if both N1 and N2 are equal to 0, values increasing by 4, such as 0, 4, 8, 12, . . . , 6248, can be expressed. In the case where a LEN unit exceeds a value set as the maximum length of an RLC PDU, the LEN unit is interpreted as the maximum size of an RLC PDU. That is, if a LEN unit indicates 6252 when the maximum length of an RLC PDU is 6250, the LEN unit is interpreted as 6250. When a LEN unit has a value greater than N1, the LEN unit means a value greater than 2 bytes, but all values within a corresponding range cannot be expressed. Thus, in such a case, the RLC layer of the transmitter generates an RLC PDU with a size expressible by a LEN unit by adding as many padding as is expressed by the LEN unit.

As a variant of the second embodiment of the present invention, a LEN field may be set as illustrated in FIG. 9B. FIG. 9B illustrates a graph for setting and interpreting a field for indicating the length of an RLC PDU according to a second example of the second embodiment of the present invention. When an RLC PDU has a length as given in FIG. 9B, the length of the RLC PDU may be calculated by a specific equation in a similar manner as in FIG. 9A, and may also be previously mapped to a corresponding LEN field value. The latter is also true of FIG. 9A.

Comparison between FIG. 9A and FIG. 9B is as follows: In FIG. 9A, RLC PDUs with smaller lengths can be precisely expressed. That is, as seen from the curve 701, values of up to N1 can express RLC PDU lengths at face value. However, it is difficult to precisely express RLC PDU lengths by values of N1 to N2, and precision is significantly lowered for values greater than N2. Contrarily, in FIG. 9B, RLC PDUs with smaller lengths are not precisely expressed as seen from a curve 711 corresponding to values of up to N1, but values of N1 to N2 can precisely express RLC PDU lengths as compared to the values of up to N1, and values greater than N2 can more precisely express RLC PDU lengths. Thus, in the case of FIG. 9B, it is preferred to use values determined base on a preset table rather than to make a graph by using equations. This is because using less number of AC headers is advantageous to reduce signaling overhead. Further, in the case of FIG. 9B, padded information can be reduced when mass data is transmitted. Furthermore, since the length of an RLC PDU may generally increase when high-speed data is transmitted, it may be preferred to express RLC PDUs with larger lengths more precisely than RLC PDUs with smaller lengths.

Reference will now be made to transmission and reception operations in the first example of the second embodiment of the present invention. However, the second example in FIG. 9A may also be implemented in a similar manner.

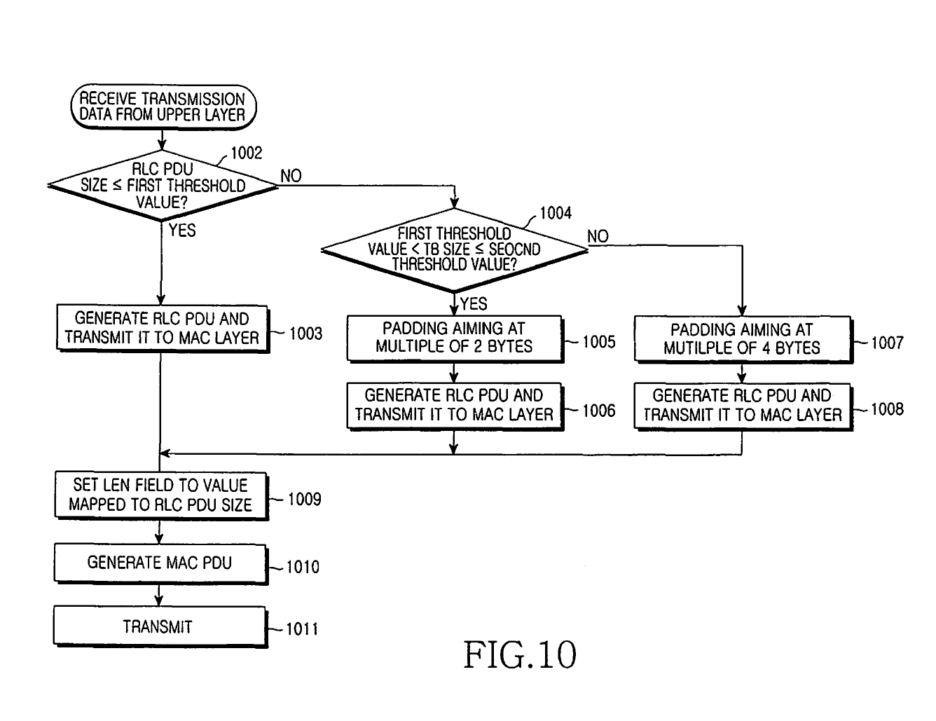

FIG. 10 illustrates a control flowchart for setting an RLC PDU in a transmitter according to the first example of the second embodiment of the present invention.

On receiving transmission data from an upper layer, each RLC transmission unit 410a, 410b, 410c proceeds to step 1002, and checks if the length of an RLC PDU to be transmitted is equal to or less than a first threshold value. If a result of the checking in step 1002 shows that the RLC PDU length is equal to or less than the first threshold value, the RLC transmission unit proceeds to step 1003, and otherwise proceeds to step 1004. In step 1004, the RLC transmission unit 410a, 410b, 410c checks if the length of an RLC PDU to be transmitted is greater than the first threshold value and is not greater than a second threshold value. If a result of the checking in step 1004 shows that the RLC PDU length is greater than the first threshold value and is not greater than the second threshold value, the RLC transmission unit 410a, 410b, 410c proceeds to step 1005, and otherwise proceeds to step 1007.

The case where the RLC transmission unit 401a, 401b, 410c proceeds from step 1002 to step 1003 is a common case. On proceeding to step 1003, each RLC transmission unit 410a, 410b, 410c generates an RLC PDU to be transmitted, and forwards the generated RLC PDU to the data construction unit 411. The data construction unit 411 then receives RLC PDUs from the respective RLC transmission units 410a, 410b, 410c, generates a MAC SDU by joining the RLC PDUs, and then outputs the generated MAC SDU to the MAC header insertion unit 412. The MAC header insertion unit 412 proceeds to step 1009, sets a LEN field to a value mapped to the length of each RLC PDU, and configures each MAC header. Also, the MAC header insertion unit 412 proceeds to step 1010, and generates a MAC PDU by inserting the generated MAC headers into the MAC SUD. In step 1011, the MAC PDU generated in this way is coded and modulated by the HARQ control unit 413, and finally is transmitted to a receiver through the transmission/reception unit 414 after up-converted to a high band.

The case where the RLC transmission unit 410a, 410b, 410c proceeds from step 1004 to step 1005 is a case where the length of an RLC PDU is expressed by a value greater than N1 and less than N2, as discussed in FIG. 9a. Thus, in order to express an RLC PDU to be transmitted by a value greater than N1, each RLC transmission unit 410a, 410b, 410c performs padding with zeros (0) such that the length of an RLC PDU is a multiple of 2 bytes. Subsequently, each RLC transmission unit 410a, 410b, 410c proceeds to step 1006, generates an RLC PDU by using the padded data, and then forwards the generated RLC PDU to the data construction unit 411. The data construction unit 411 then receives RLC PDUs from the respective RLC transmission units 410a, 410b, 410c, generates a MAC SUD by joining the RLC PDUs in such a manner as to match to a TB size, and then outputs the generated MAC SDU to the MAC header insertion unit 412. The MAC header insertion unit 412 then proceeds to step 1009, and set a LEN field to a value mapped to the length of each RLC PDU. Also, the MAC header proceeds to step 1010, and generates a MAC PDU by insertion the set LEN field into the MAC SDU. In step 1011, the MAC PDU generated in this way is coded and modulated by the HARQ control unit 413, and finally is transmitted to a receiver through the transmission/reception unit 414 after up-converted to a high band.

More specially, the process of setting a LEN field in step 1009 is performed as follows: In step 1009, since a LEN field is set for an RLC PDU, the length of which becomes greater than the first threshold value and equal to or less than the second threshold value through steps 1005 and 1006, it is set by specifying a LEN unit as given in Equation (1).

The case where the RLC transmission unit 410a, 410b, 410c proceeds from step 1004 to step 1007 is a case where the length of an RLC PDU is expressed by a value greater than N2, as discussed in FIG. 9a. Thus, in order to express an RLC PDU to be transmitted by a value greater than N2, each RLC transmission unit 410a, 410b, 410c performs padding with zeros (0) such that the length of an RLC PDU is a multiple of 4 bytes. Subsequently, each RLC transmission unit 410a, 410b, 410c proceeds to step 1008, generates an RLC PDU by using the padded data, and then forwards the generated RLC PDU to the data construction unit 411. The data construction unit 411 then receives RLC PDUs from the respective RLC transmission units 410a, 410b, 410c, generates a MAC SUD by joining the RLC PDUs in such a manner as to match to a TB size, and then outputs the generated MAC SDU to the MAC header insertion unit 412. The MAC header insertion unit 412 then proceeds to step 1009, and set a LEN field to a value mapped to the length of each RLC PDU. Also, the MAC header proceeds to step 1010, and generates a MAC PDU by inserting the set LEN fields into the MAC SDU. In step 1011, the MAC PDU generated in this way is coded and modulated by the HARQ control unit 413, and finally is transmitted to a receiver through the transmission/reception unit 414 after up-converted to a high band.

More specially, the process of setting a LEN field in step 1009 is performed as follows: In step 1009, since a LEN field is set for an RLC PDU, the length of which becomes greater than the second threshold value through step 1007 and 1008, it is set in such a manner that a LEN unit falls within a range as given in Equation (3).

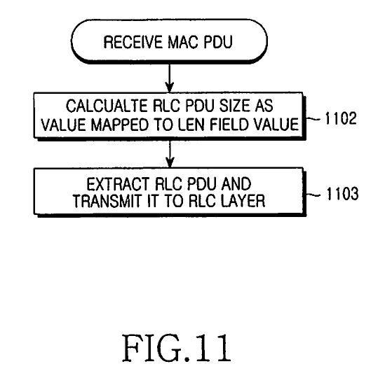

FIG. 11 illustrates a control flowchart for interpreting an RLC PDU in a receiver according to the first example of the second embodiment of the present invention. The first example of the second embodiment of the present invention may be implemented without performing header checking in the control channel processing unit 521. Thus, in the second embodiment of the present invention, any particular operation of the control channel processing unit 521 will not be described.

On receiving an on-air transmitted MAC PDU through the transmission/reception unit 510 and the HARQ unit 511, in step 1102, the MAC header interpretation unit 512 calculates the length of an RLC PDU by means of a value mapped to the value of a LEN field. Such a calculation is performed by a normal interpretation method, a method using a value as given in Equation (2), and a method using a value as given in Equation (3). This interpretation method is a method of interpreting the length of an RLC PDU in a different manner according to which value a LEN unit has. After the MAC header interpretation unit 512 interprets the LEN field in step 1102, it provides the data separation unit 513 with interpreted information and a MAC SDU. In step 1103, the data separation unit 513 then extracts RLC PDUs from the MAC SDU, and provides them to the respective reception units 514a, 514b, 514c of the RLC layer 514.

For the second example of the second embodiment of the present invention, setting and interpretation are possible in a similar manner to that in the first example, so a detailed description thereof will be omitted. Through the aforementioned second embodiment of the present invention, data can be expressed without increasing the size of a MAC header, even when the length of a transmitted RLC PDU increases. Thus, the overall system throughput can be improved, and system overhead can be reduced.

A third embodiment of the present invention proposes a method of variably using a LEN field size according to TB sizes. First, when a TB size is equal to or less than 2047, a value of 0 to 2047 is expressed using an 11 bit-LEN field. Second, when a TB size is greater than 2047 and less than 4095, a value of 0 to 4095 is expressed using a 12-bit LEN field. Finally, when a TB size is greater than 4095, a value of 0 to 6250 (i.e., maximum length of an RLC PDU) is expressed using a 13-bit LEN field. In this way, the number of bits used in a LEN field varies according to TB sizes.

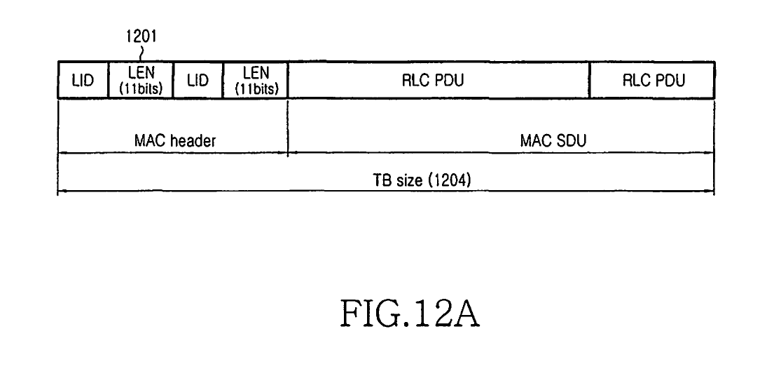

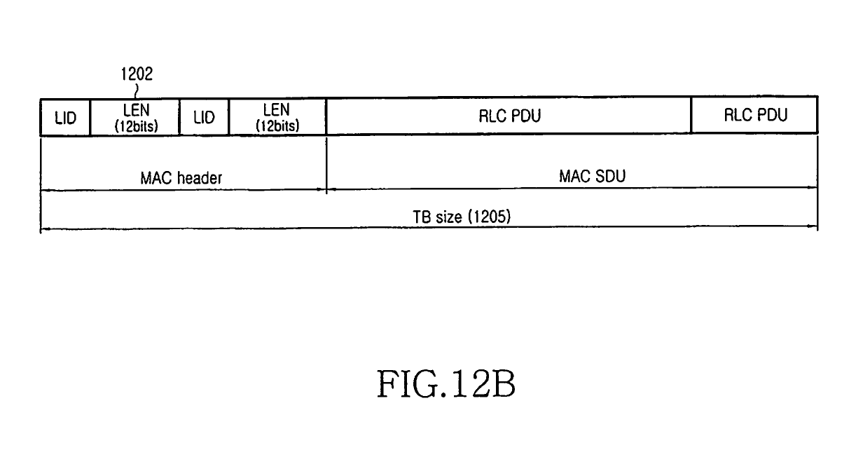

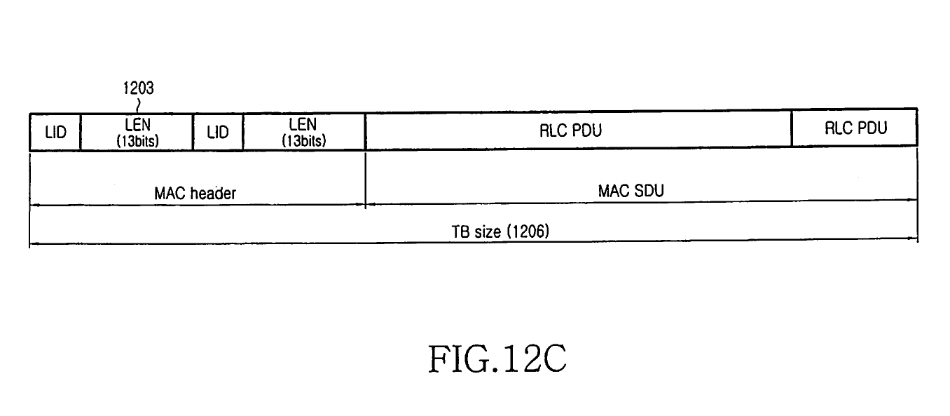

FIGS. 12A to 12C illustrate the overall structure of a MAC PDU according to the third embodiment of the present invention. FIG. 12A shows a case where the length of a LEN field is 11 bits, FIG. 12B shows a case where the length of a LEN field is 12 bits, and FIG. 12C shows a case where the length of a LEN field is 13 bits. Thus, an RLC PDU length equal to or less than 2047 can be expressed in the case of FIG. 12A, an RLC PDU length of 2048 to 4095 can be expressed in the case of FIG. 12B, and an RLC PDU length of 4096 to 8191 can be expressed in the case of FIG. 12C. FIGS. 12A to 12C shows a few examples, and when an RLC PDU length is greater or less than in FIGS. 12A to 12C, the length of a LEN field may be more variable. Also, when the length of a LEN field is changed in this way, each change thereof is informed over a control channel, a LEN field length to be used during a specific period is prearranged, or a LEN field to be used is determined according to UE grades so that confusion during transmission/reception can be avoided.

When the third embodiment of the present invention is used, there is an advantage in that all RLC PDU lengths can be expressed corresponding to all cases, and a LEN field can be prevented from unnecessarily increasing.

According to the present invention as describe above, a data size can be sufficiently indicated without a substantial increase in a header size. As a result of this, the overall system throughput can be improved, and signaling overhead can be reduced.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of setting a Media Access Control (MAC) packet header when a MAC packet is transmitted in a mobile communication system, the method comprising the steps of:
setting a Length (LEN) unit of the MAC packet header to 1 byte when a Transport Block (TB) size is less than or equal to a first predetermined threshold value; and
setting the LEN unit to 2 bytes when the TB size is greater than the first predetermined threshold value and is less than or equal to a second predetermined threshold value.

2. The method as claimed in claim 1, further comprising setting the LEN unit to 4 bytes when the TB size is greater than the second predetermined threshold value.

3. The method as claimed in claim 2, further comprising generating a TB with a size set in a LEN field by padding the TB with zeros (0) when the TB size is greater than the first predetermined threshold value and is different from the size set in the LEN field.

4. The method as claimed in claim 2, further comprising transmitting information on the TB size over a control channel.

5. The method as claimed in claim 1, further comprising generating a TB with a size set in a LEN field by padding the TB with zeros (0) when the TB size is greater than the first predetermined threshold value and is different from the size set in the LEN field.

6. The method as claimed in claim 1, further comprising transmitting information on the TB size over a control channel.

7. A method of interpreting a Media Access Control (MAC) packet header when a MAC packet is received in a mobile communication system where size information of a Transport Block (TB) transmitted over a traffic channel is provided over a control channel, the method comprising the steps of:
receiving the size information of the TB over the control channel;
interpreting a LEN field of the MAC packet header at face value when the received size information is less than or equal to a first predetermined threshold value; and
interpreting the LEN field of the MAC packet header as indicating a size that is as twice as large as a LEN field value when the received size information is greater than the first predetermined threshold value and is less than or equal to a second predetermined threshold value.

8. The method as claimed in claim 7, further comprising interpreting the LEN field of the MAC packet header as indicating a size that is four times as large as the LEN field value when the received size information is greater than the second predetermined threshold value.

9. An apparatus for setting a Media Access Control (MAC) packet header when a MAC packet is transmitted in a mobile communication system, the apparatus comprising:
at least one Radio Link Control (RLC) transmission unit for splitting application data received from an upper layer into transport data blocks with a size transmittable over a traffic channel, and outputting the split data blocks;
a data construction unit for generating a Transport Block (TB) to be transmitted over the traffic channel by joining the transport data blocks;
a control unit for setting a LEN unit of a header of the TB to 1 byte when a TB size is less than or equal to a first predetermined threshold value, and setting the LEN unit of the header of the TB to 2 bytes when the TB size is greater than the first predetermined threshold value and is less than or equal to a second predetermined threshold value; and
a header insertion unit for inserting the header, the LEN unit of which has been set.

10. The apparatus as claimed in claim 9, wherein the control unit sets the LEN unit to 4 bytes when the TB size is greater than the second predetermined threshold value.

11. The apparatus as claimed in claim 10, wherein the data construction unit generates the TB with a size set in a LEN field included in the header of the TB by padding the TB with zeros (0) when the TB size is greater than the first predetermined threshold value and is different from the size set in the LEN field.

12. The apparatus as claimed in claim 10, further comprising a control channel transmission unit for transmitting size information of the TB over a control channel.

13. The apparatus as claimed in claim 9, wherein the data construction unit generates the TB with a size set in a LEN field included in the header of the TB by padding the TB with zeros (0) when the TB size is greater than the first predetermined threshold value and is different from the size set in the LEN field.

14. The apparatus as claimed in claim 9, further comprising a control channel transmission unit for transmitting size information of the TB over a control channel.

15. The apparatus as claimed in claim 9, further comprising a Hybrid Automatic Retransmission Request (HARQ) control unit for controlling HARQ of transmitted data.

16. An apparatus for interpreting a Media Access Control (MAC) packet header when a MAC packet is received in a mobile communication system where size information of a Transport Block (TB) transmitted over a traffic channel is provided over a control channel, the apparatus comprising:
a control channel processing unit for checking the size information of the TB, received over the control channel, to thereby detect a TB size, interpreting a LEN field of the MAC packet header at face value when the TB size is less than or equal to a first predetermined threshold value, and interpreting the LEN field of the MAC packet header as indicating a size that is twice as large as a LEN field value when the TB size is greater than the first predetermined threshold value and is equal to or less than a second predetermined threshold value;
a MAC packet header interpretation unit for interpreting the MAC packet header under the control of the control channel processing unit; and
a data separation unit for separately outputting transport data blocks of the MAC packet by using interpretation information forwarded from the MAC packet header interpretation unit.

17. The apparatus as claimed in claim 16, wherein the control channel processing unit controls the MAC packet header interpretation unit to interpret the LEN field of the MAC packet header as indicating a size that is four times as large as the LEN field value when the TB size is greater than the second predetermined threshold value.

18. The apparatus as claimed in claim 16, further comprising a Hybrid Automatic Retransmission Request (HARQ) control unit for detecting errors of the received MAC packet, and requesting HARQ when the errors are detected.

19. The apparatus as claimed in claim 16, further comprising at least a Radio Link Control (RLC) reception unit for processing the separated data blocks according to respective application data.

20. A method of setting a Media Access Control (MAC) packet header when a MAC packet is transmitted in a mobile communication system, the method comprising the steps of:
setting a length of a Length (LEN) field included in the MAC packet header according to a Transport Block (TB) size;
transmitting a control channel for informing a receiving side of the length of the LEN field included in the MAC packet header;
indicating the TB size by the set length of the LEN field to thereby configure the MAC packet; and
transmitting the MAC packet over a traffic channel.

21. The method as claimed in claim 20, further comprising informing the receiving side of a length of the MAC packet through the control channel.

22. The method as claimed in claim 20, further comprising generating a TB with a LEN field size by padding the TB with zeros (0) when the TB size is smaller than a LEN field value of the MAC packet header.
